(19) United States
(12) Patent Application Publication
(10) Pub. No.: US 2023/0067622 A1
(43) Pub. Date: Mar. 2, 2023

(54) DISTRIBUTED FIREWALLS USING IPV4 TTL/IPV6 HOP LIMIT

(71) Applicant: FLIPKART INTERNET PRIVATE LIMITED, Bangalore (IN)

(72) Inventors: Aftab Ahmad ANSARI, Bangalore (IN); Krishna KUMAR, Bangalore (IN); Raghdipsingh Raghbirsingh PANESAR, Bangalore (IN)

(21) Appl. No.: 17/858,586

(22) Filed: Jul. 6, 2022

(30) Foreign Application Priority Data
Jul. 6, 2021 (IN) 202141030332

(51) Int. Cl. H04L 47/28; H04L 47/32; H04L 9/40

(52) U.S. Cl. CPC H04L 47/286; H04L 47/32; H04L 63/0263

(57) ABSTRACT

Method and system relating to firewall configuration have been discussed. According to an embodiment, a method comprises specifying at least one firewall configuration at a first server at which the at least one firewall configuration is to be enforced; to a plurality of servers, distributing the at least one specified firewall configuration along with a set of parameters to identify the plurality of servers at which the at least one specified firewall configuration has to be enforced; receiving a data packet by a second server of the plurality of servers from the first server; and comparing the at least one specified firewall configuration with a default set of firewall configuration while receiving the data packet by the second server of the plurality of servers from the first server.

### TECHNICAL FIELD

The present invention relates generally to cloud networking. More particularly, the present invention relates to achieving distributed firewalling capability over a large fleet of servers using IPv4 ttl / IPv6 hop limit.

### BACKGROUND

A firewall is a device, or an application running on a device, used to permit or deny network transmissions based upon a set of rules. A firewall may be used to protect a network from unauthorized access while permitting legitimate communications to pass. A firewall may have an outward side facing a global network, such as the Internet. The opposite side of the firewall may be a private network which is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Creating network isolation and securing networks have been around for a long time. Early solutions revolved around having a centralised firewall tier where any traffic that moved from one administrative domain to another was made to pass through this centralised tier.

As traffic levels increased, it became clear that this method of centralisation for traffic policing would not scale.

This gave way to a wave of software defined solutions to achieve this. The core principle of many of these solutions was to distribute the isolation policies on to the edge nodes rather than a centralised tier.

In traditional networks where the isolation is using defined parameters (for example: Subnet A can communicate with Subnet B; Subnet A cannot communicate with Subnet C) this method works and is fairly straightforward and static in nature. All participating edges in the network have the same set of rules and the propagation doesn’t need to bear additional context.

Private cloud deployments with tens of thousands of servers are designed for maximum efficiency and bin packing of resources. The notion of a service or an administrative domain is no longer restricted to a subnet or any defined parameter.

(Instances refers to any virtualisation technology, including VM, container, docker, etc)

This creates a problem where Service A, which at one moment could comprise of 1000 instances on 1000 unique servers, and the next could comprise of 500 completely different instances on 500 unique servers.

If Service A has rules to permit communication with Services W, X, Y and Z; Because of scale up or scale down of Service A, rules would need to be propagated to all the servers that host instances of Services A, W, X, Y and Z.

Quick propagation of rules is not possible in this case.

Additionally, if the frequency of such changes is high, the time to propagate and keep the rules consistent across all the servers becomes highly complex.

### Known Solutions

In an environment where a service can scale from a couple of instances to thousands of instances and again shrink to a finite number of instances, there’s a cloud controller that oversees these changes. This cloud controller has the full view of what the service definition is, in terms of IP addresses at all times.

Isolation policies defined for inter-service communication, coupled with the IP address information from a cloud controller, are used to create rules such as:
Service A (set of IP addresses) ←permit→ Service B (set of IP addresses)
all others (set of IP addresses) ←deny→ all others (set of IP addresses)

These rules are default deny and only permit communications that are explicitly permitted; Because of this, every-time there’s a churn in instances, new rules have to be propagated to all participating servers and only then can this be called a successful deployment.

This creates a problem where an instance cannot be considered to be available unless these rules are propagated across all the servers.

For an environment where the churn of instances is not high, the delay in propagating these rules and thereby delay in marking the instance ready can be absorbed.

But in environments where the churn of instances is high, this could lead to extremely high delays in propagating these rules which would add considerable time delay to marking the instances as ready. This method hence proves suboptimal for such deployments.

Having said that, both these environments would benefit from removal of this additional latency as described in the following sections.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter.

Its sole purpose to present some concepts of the subject matter in a simplified form as a prelude to the more detailed description that is presented later.

According to an embodiment of the present application, a method for specifying firewall configuration has been disclosed. The method comprises specifying at least one firewall configuration at a first server at which the at least one firewall configuration is to be enforced; to a plurality of servers, distributing the at least one specified firewall configuration along with a set of parameters to identify the plurality of servers at which the at least one specified firewall configuration has to be enforced; receiving a data packet by a second server of the plurality of servers from the first server; and comparing the at least one specified firewall configuration with a default set of firewall configuration while receiving the data packet by the second server of the plurality of servers from the first server, wherein a Time-to-Live (TTL) parameter is set in order to receive the data packet.

According to an embodiment of the present application, the TTL parameter is responsible for receiving or dropping of the data packet at the first server.

According to an embodiment of the present application, the first server is associated with the second server of the plurality of servers.

According to an embodiment of the present application, the at least one specified firewall configuration is modified based on certain instances and the modified firewall configuration is distributed across the plurality of servers.

According to an embodiment of the present application, a firewall system is disclosed. The firewall system comprises a plurality of servers wherein the plurality of servers are configured to: specify at least one firewall configuration at a first server at which the at least one firewall configuration is to be enforced; distribute the at least one specified firewall configuration along with a set of parameters to identify the plurality of servers at which the at least one specified firewall configuration has to be enforced; and compare the at least one specified firewall configuration with a default set of firewall configuration while receiving a data packet by a second server of the plurality of servers from the first server, wherein a Time-to-Live (TTL) parameter is set in order to receive the data packet.

According to an embodiment of the present application, the TTL parameter is responsible for receiving or dropping of the data packet at the first server.

According to an embodiment of the present application, the first server is associated the second server of the plurality of servers.

According to an embodiment of the present application, the at least one specified firewall configuration is modified based on certain instances and the modified firewall configuration is distributed across the plurality of servers.

According to an embodiment of the present application, a method has been disclosed. The method comprising: performing a look up on a table present at a plurality of servers; setting a Time-to-Live (TTL) parameter based on the table, wherein a specific configuration is set in the TTL parameter; transmitting a data packet based on the TTL parameter from a first server to a second server of the plurality of servers, wherein the data packet is transmitted when the TTL parameter is over a predefined threshold value.

According to an embodiment of the present application, the transmission of data packet is stopped at the first server when a set of rules associated with the table of the first server is matched with that of the second server.

According to an embodiment of the present application, in case of non-transmission of the data packet from the first server to the second server, the second server runs a set of rules in an another table present in the second server.

According to an embodiment of the present application, a firewall system has been disclosed. The system comprising: a plurality of servers wherein the plurality of servers are configured to: perform a look up on a table present at the plurality of servers; set a Time-to-Live (TTL) parameter based on the table, wherein a specific configuration is set in the TTL parameter; transmit a data packet based on the TTL parameter from a first server to a second server of the plurality of servers, wherein the data packet is transmitted when the TTL parameter is over a predefined threshold value.

According to an embodiment of the present application, the transmission of data packet is stopped at the first server when a set of rules associated with the table of the first server is matched with that of the second server.

According to an embodiment of the present application, in case of non-transmission of the data packet from the first server to the second server, the second server runs a set of rules in an another table present in the second server.

### BRIEF DESCRIPTION OF FIGURES

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting of its scope, for the subject matter may admit to other equally effective embodiments.

FIG. 1 illustrates about the data transmission according to a general embodiment of the present invention.

FIG. 2 illustrates a system used for firewall configuration according to an embodiment of the present invention.

FIG. 3 illustrates a method according to an embodiment of the present invention.

FIG. 4 illustrates a method according to an another embodiment of the present invention.

### DETAILED DESCRIPTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting of its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. The use of IPv6 and IPv4 are used for ease of understanding; a person skilled in the art can interchangeable use the various parts of IPV4 and IPv6. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the hardware and/or software components required for the unit to function. Further, each unit may comprise within itself one or more components which are implicitly understood. These components may be operatively coupled to each other and be configured to communicate with each other to perform the function of the said unit.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

This invention solves the above-described problem by using an asymmetric signalling mechanism, thereby achieving network isolation. Instant propagation of rules is limited to the finite set of servers where an instance is created or destroyed, and not to the entire fleet of servers, before an instance or service is deemed to be ready. Furthermore, an external agent is not required to propagate the initial rules, as will be shown below.

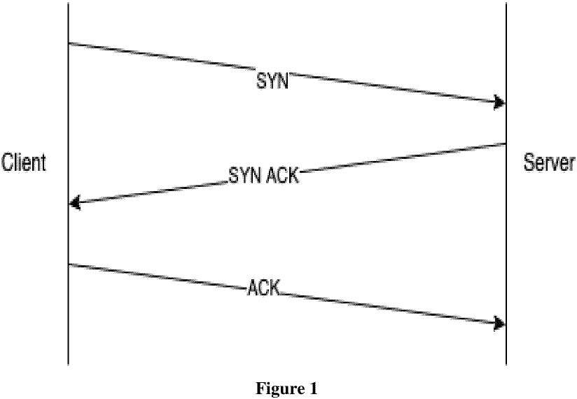

As shown in FIG. 1, in TCP, a connection request (SYN packet) needs to be received by the server’s LISTEN socket, before the connection can proceed to the next state, which involves sending a SYN+ACK packet in response. If the SYN packet is dropped or filtered before it is processed by the LISTEN socket, the connection will get timed out.

This invention takes advantage of the TTL field in the IPv4 header, or the hop-limit field in IPv6 header to achieve isolation. From here on, the term ttl is used to refer to both IPv4 TTL and IPv6 hop-limit. Time to live (TTL) is a mechanism that limits the lifespan or lifetime of a packet in a network - its value in the header is decremented by one every time the packet traverses a router, and the packet is dropped when the TTL becomes zero. The maximum TTL value is 255, and the recommended initial value is 64. For most private network deployments, destinations are at most a few layer-3 hops away.

The terminologies used in this disclosure are defined below:

Concept of a tuple: A ‘n’ tuple set comprising

[ Source-IP, Destination-IP, Source-Port, Destination-Port, Protocol ]. While Source-IP and Destination-IP are mandatory in any implementation, other fields may be optional in other embodiments of this invention. Source-IP refers to the source IP of the networking packet (either incoming or outgoing), while Destination-IP refers to the destination IP of the networking packet.

Two actions are defined:
Action A: Set TTL = A Predefined Value, indicating ACCEPT (e.g., 100)
Action B: Set TTL = A Predefined Value, indicating FAILURE (e.g., > 100)

Concept of a rule: A rule adds an action to a tuple. An example rule is: “If an outgoing packet matches this rule, execute the action mapped to the rule”.

OUTPUT Table: Set of rules which are matched and executed during packet transmission.

INPUT Table: Set of rules which are matched and executed during packet reception.

The rules in this table are temporary, where the rules are added for a short time when an instance is created, and subsequently flushed at an opportune time.

A static ttl-checker is defined for incoming packets as follows:

Accept the packet if the packet’s TTL <= ACCEPT, Drop all other packets.

For TCP isolation, it is sufficient to match only the first SYN/connection packet against INPUT/OUTPUT tables. However, for UDP/ICMP, etc, all packets can be compared to these tables for complete network isolation.

The mechanism associated with the disclosure is described below. In this regard, the mechanism can be classified into four sections:
Steady state of the system.
Mechanism during instance creation.
Mechanism during packet reception, and
Mechanism during packet transmission.

### Steady State of the System

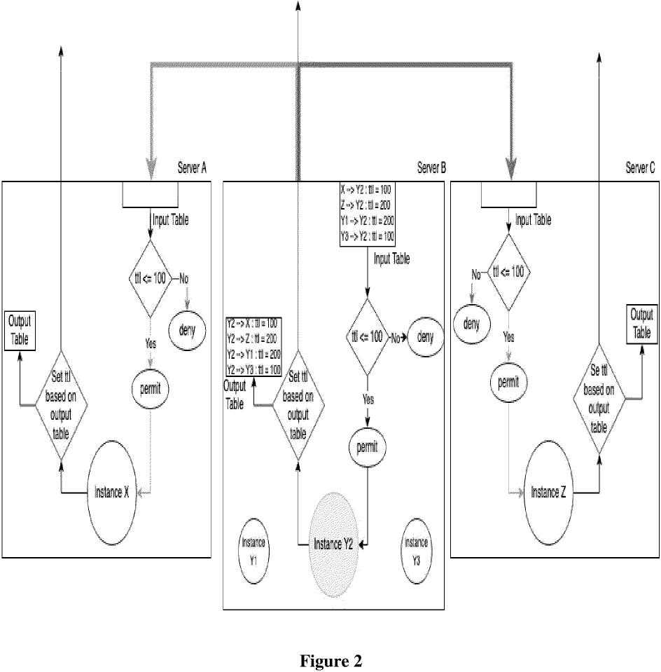

In reference with FIG. 2, in steady state of the system, every participating server has a default rule added in an OUTPUT Table as follows:

[<ANY-IP>, <ANY-PORT>, <ANY-IP>, <ANY-PORT>, TCP], FAILURE

Now, a static ttl-checker for incoming packets as:

Accept the packet if the packet’s TTL <= SUCCESS, Drop all other packets.

A default rule added in an INPUT Table as follows:

[<ANY-IP>, <ANY-PORT>, <ANY-IP>, <ANY-PORT>, TCP], FAILURE

### Mechanism During Instance Creation

Let us assume an instance Y2 is created on server B (refer FIG. 2). Furthermore, let us consider that Y2’s IP address is y2 and Y2 is allowed to communicate with X, but not with Z. One rule is created in the OUTPUT Table on server B for every endpoint that Y2 is allowed to communicate with. E.g., for communicating with X, the following rule is added:

[y2, <any-port or specific-ports>, X, <any-port or specific-ports>, TCP], SUCCESS.

(and so on for all instances that Y2 is allowed to communicate with). Another rule in the INPUT Table on server B is created for every endpoint that Y2 communicates with. e.g., for communicating with X, and the following rule is added:

[X, <any-port or specific-ports>, y2, <any-port or specific-ports>, TCP], SUCCESS.

It is worth to note that INPUT Table entries are temporary. At this time, the instance is considered to be available, with complete network isolation as desired. An event on all servers is scheduled that host the endpoints that Y2 communicates with, to add a rule in their OUTPUT Tables, which permits them to communicate successfully with Y2.

When the event handler executes, it creates a rule on all the servers which host endpoints that Y2 communicates with, adding a rule in those server’s OUTPUT Tables with the contents:

[end-point#1, <any-port or specific-ports>, y2, <any-port or specific-ports>, TCP], SUCCESS.

As an example, the following rule may be added on server A:

[X, <any-port or specific-ports>, y2, <any-port or specific-ports>, TCP], SUCCESS.

After Output Table rules are created on all servers as identified above, the temporary INPUT Table rules added on server B are deleted. These INPUT Table rules are no longer required as all communication endpoints now have a rule in their OUTPUT Tables allowing communication with Y2.

### Mechanism During Packet Reception

On packet reception, the packet parameters are matched against the INPUT Table entries, and the matched action is acted upon. E.g., if Server B received a packet for instance Y2 from instance X, one of the following two cases would be true:
1. If instance Y2 was just created, Server A (which hosts instance X) would not have a corresponding OUTPUT Table rule for instance X to communicate with instance Y2. So the ttl of the incoming packet will be FAILURE. In this case, server B would have a temporary INPUT Table rule specifying:
   [X, <any-port or specific-ports>, y2, <any-port or specific-ports>, TCP], SUCCESS.
   This results in server B setting the TTL of the packet to SUCCESS.
2. If the rules were already propagated to the communicating endpoints, server A would have set the TTL to SUCCESS.

It is to be noted that if server B received a packet for instance Y2 from Z, the packet would match the default rule in the INPUT Table, which sets the TTL of the packet to FAILURE. In this case, server C that hosted instance Z would likely have set the TTL to FAILURE already. But, the default rule in the INPUT Table is retained, as the receiver is finally responsible for accepting or rejecting incoming packets.

Next the packet goes to the ttl-checker. If the packet’s TTL is SUCCESS (<= 100), the packet continues on the receive path, else the packet is dropped.

### Mechanism During Packet Transmission

When a packet is being transmitted, a lookup in the OUTPUT Table is performed, and set the TTL according to the action. Either a specific rule provides a value of SUCCESS to the TTL, else the default rule matches which sets the TTL to FAILURE.

It is to be noted that the packet on FAILURE cannot be dropped, as the instance may have just been created and the rules have not been propagated. In this case, the receiver would check it’s INPUT Table for a matching rule and take action accordingly. Henceforth, packet continues on the transmit path.

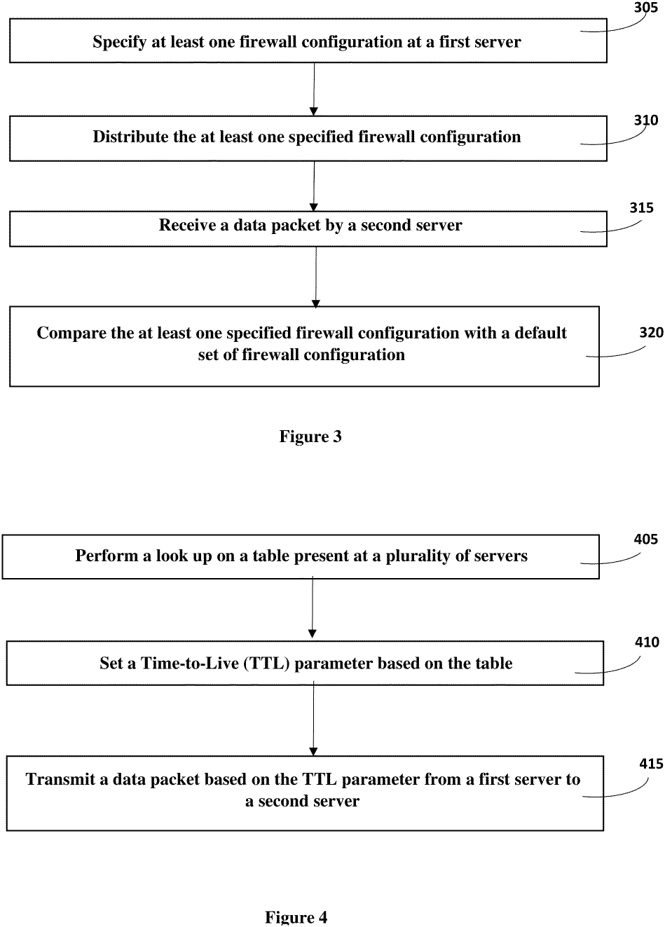

FIG. 3 refers to a method for specifying firewall rules while receiving a data packet. Accordingly, in step 305, at least one firewall configuration at a first server is specified at which the at least one firewall configuration is to be enforced. At step 310, to a plurality of servers, the at least one specified firewall configuration along with a set of parameters are distributed to identify the plurality of servers at which the at least one specified firewall configuration has to be enforced. At step 315, a data packet is received by a second server of the plurality of servers from the first server. At step 320, the at least one specified firewall configuration is compared with a default set of firewall configuration while receiving the data packet by the second server of the plurality of servers from the first server, wherein a Time-to-Live (TTL) parameter is set in order to receive the data packet. The TTL parameter is responsible for receiving or dropping of the data packet at the first server. The first server is associated with the second server of the plurality of servers. The at least one specified firewall configuration is modified based on certain instances and the modified firewall configuration is distributed across the plurality of servers.

FIG. 4 refers to a method for specifying firewall rules while transmitting a data packet. Accordingly, at step 405, a look up is performed on a table present at a plurality of servers. At step 410, a Time-to-Live (TTL) parameter is set based on the table, wherein a specific configuration is set in the TTL parameter. At step 415, a data packet is transmitted based on the TTL parameter from a first server to a second server of the plurality of servers, wherein the data packet is transmitted when the TTL parameter is over a predefined threshold value. The transmission of data packet is stopped at the first server when a set of rules associated with the table of the first server is matched with that of the second server. In case of non-transmission of the data packet from the first server to the second server, the second server runs a set of rules in an another table present in the second server.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method comprising:
specifying at least one firewall configuration at a first server at which the at least one firewall configuration is to be enforced;
to a plurality of servers, distributing the at least one specified firewall configuration along with a set of parameters to identify the plurality of servers at which the at least one specified firewall configuration has to be enforced;
receiving a data packet by a second server of the plurality of servers from the first server; and
comparing the at least one specified firewall configuration with a default set of firewall configuration while receiving the data packet by the second server of the plurality of servers from the first server,
wherein a Time-to-Live (TTL) parameter is set in order to receive the data packet.

2. The method as claimed claim 1, wherein the TTL parameter is responsible for receiving or dropping of the data packet at the first server.

3. The method as claimed in claim 1, wherein the first server is associated with the second server of the plurality of servers.

4. The method as claimed in claim 1, wherein the at least one specified firewall configuration is modified based on certain instances and the modified firewall configuration is distributed across the plurality of servers.

5. A firewall system comprising:
a plurality of servers wherein the plurality of servers are configured to:
specify at least one firewall configuration at a first server at which the at least one firewall configuration is to be enforced;
distribute the at least one specified firewall configuration along with a set of parameters to identify the plurality of servers at which the at least one specified firewall configuration has to be enforced; and
compare the at least one specified firewall configuration with a default set of firewall configuration while receiving a data packet by a second server of the plurality of servers from the first server,
wherein a Time-to-Live (TTL) parameter is set in order to receive the data packet.

6. The system as claimed in claim 5, wherein the TTL parameter is responsible for receiving or dropping of the data packet at the first server.

7. The system as claimed in claim 5, wherein the first server is associated with the second server of the plurality of servers.

8. The system as claimed in claim 5, wherein the at least one specified firewall configuration is modified based on certain instances and the modified firewall configuration is distributed across the plurality of servers.

9. A method comprising:
performing a look up on a table present at a plurality of servers;
setting a Time-to-Live (TTL) parameter based on the table, wherein a specific configuration is set in the TTL parameter;
transmitting a data packet based on the TTL parameter from a first server to a second server of the plurality of servers,
wherein the data packet is transmitted when the TTL parameter is over a predefined threshold value.

10. The method as claimed in claim 9, wherein the transmission of data packet is stopped at the first server when a set of rules associated with the table of the first server is matched with that of the second server.

11. The method as claimed in claim 10, wherein in case of non-transmission of the data packet from the first server to the second server, the second server runs a set of rules in an another table present in the second server.

12. A firewall system comprising:
a plurality of servers wherein the plurality of servers are configured to:
perform a look up on a table present at the plurality of servers;
set a Time-to-Live (TTL) parameter based on the table, wherein a specific configuration is set in the TTL parameter;
transmit a data packet based on the TTL parameter from a first server to a second server of the plurality of servers,
wherein the data packet is transmitted when the TTL parameter is over a predefined threshold value.

13. The system as claimed in claim 12, wherein the transmission of data packet is stopped at the first server when a set of rules associated with the table of the first server is matched with that of the second server.

14. The method as claimed in claim 12, wherein in case of non-transmission of the data packet from the first server to the second server, the second server runs a set of rules in an another table present in the second server.
